(19) United States
(12) Patent Application Publication
(10) Pub. No.: US 2007/0232366 A1
(43) Pub. Date: Oct. 4, 2007

(54) Method and system for power-efficient monitoring of wireless broadcast network

(75) Inventors: An Mei Chen, San Diego, CA (US); Ravinder Paul Chandhok, Poway, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/394,065

(22) Filed: Mar. 29, 2006

(51) Int. Cl. H04B 1/38

(52) U.S. Cl. 455/574

(57) ABSTRACT

The disclosure is directed to a mobile communication device that may receive wireless broadcast signals from a number of different base stations or transmitters. The device alternates its operation between a low-power mode and a higher-power mode to conserve battery power. The length of time the device remains in the sleep mode is its sleep interval. The sleep interval is a function of two components. One component is set by the wireless broadcast network and the other component is set by the carrier that provisions the mobile communications device. When the device awakens from the sleep mode, it can check the status of any notification messages. If there are any updates, then it will process them. If there are no updates, then it will return to the low-power mode.

### BACKGROUND

1. Field

The present disclosure relates generally to telecommunications, and more particularly, to systems and methods to support a mobile communications device capable of communicating via a wireless broadcast network.

2. Background

Wireless and wireline broadcast networks are widely deployed to provide various data content to a large group of users. A common wireline broadcast network is a cable network that delivers multimedia content to a large number of households. A cable network typically includes headends and distribution nodes. Each headend receives programs from various sources, generates a separate modulated signal for each program, multiplexes the modulated signals for all of the programs onto an output signal, and sends its output signal to the distribution nodes. Each program may be distributed over a wide geographic area (e.g., an entire state) or a smaller geographic area (e.g., a city). Each distribution node covers a specific area within the wide geographic area (e.g., a community). Each distribution node receives the output signals from the headends, multiplexes the modulated signals for the programs to be distributed in its coverage area onto different frequency channels, and sends its output signal to households within its coverage area. The output signal for each distribution node typically carries both national and local programs, which are often sent on separate modulated signals that are multiplexed onto the output signal.

A wireless broadcast network transmits data over the air to wireless devices within the coverage area of the network. However, a wireless broadcast network can differ from a wireline broadcast network in several key regards. One way in which the two types of networks differ is that mobile handsets within the wireless broadcast network must be much more conscious of power efficiency and battery life. This concern has been previously addressed in various wireless unicast network but not broadcast networks. In previous types of unicast wireless networks such as, for example, CDMA, a wake-up interval is used to periodically activate the CDMA handset from a low-power sleep mode. If no paging information is waiting for the handset, then it returns to sleep mode until is awoken again. Within the unicast CDMA environment, the handset's wake-up interval is set by an agreed-upon industry standard and, therefore, does not vary between handsets.

In a wireless broadcast network, it would appear that it is unnecessary to have an active handset for the broadcast signals unless an application on the handset was actively receiving broadcast content. With no active applications, the handset could remain in a low power mode until an application was explicitly started by a user. Such assumptions do not consider that changes can take place to the control channel of the broadcast network that handsets should be made aware of even if they have no active applications. Additionally, many broadcast networks contemplate having an alert service or a notification service that operates asynchronously with any applications on the mobile broadcast handset. Accordingly, there is a need for methods and techniques to allow operation of a mobile handset in a wireless broadcast network that also improves power efficiency and increase battery life

### SUMMARY

One aspect of a mobile communications device relates to a device that includes a receiver configured to receive signals from a wireless broadcast network when operating in a first mode and a memory configured to store a configurable parameter. The mobile communications device also includes a processor configured to periodically alternate operating the receiver in a second mode and the first mode, the second mode being a lower power mode as compared to the first mode, and wherein operating in the second mode lasts for a predetermined interval, a length of which based on the configurable parameter and an index value received from the wireless broadcast network.

Another aspect of a mobile communications device relates to a method of operating the device. In accordance with this method, a receiver is operated in a first mode for a predetermined interval, wherein a length of the interval depends on an index value received from the wireless broadcast network and a configurable parameter stored in the device. After expiration of the predetermined interval, the receiver of the device is operated in a second mode to receive signals from a wireless broadcast network, wherein operating in the first mode consumes less power than operating in the first mode. Also, while the receiver is operating in the first mode, it is determined whether the signals include an indication that a notification message update occurred during a most recent operating interval in the first mode. If there is the indication, then the receiver remains operating in the second mode to determine an update. If there is no indication, then the receiver returns to operating in the first mode and the process repeats.

Yet another aspect of a mobile communications device relates to a device that includes a receiver configured to operate in either an active mode or a sleep mode, wherein the sleep mode provides lower power consumption compared to the active mode and a memory configured to store a configurable parameter. The device also includes a processor that controls the operation of the device and is configured to:

a) operate the receiver in the active mode to receive signals from a wire less broadcast network;

b) decode an index value contained within a control channel of the signals;

c) operate the receiver in the sleep mode for a predetermined interval, the predetermine interval having a length dependent on both the configurable parameter and the index value; and

d) change the receiver from the sleep mode to the active mode at the end of the interval.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Various aspects of a wireless communications system are illustrated by way of example, and not by way of limitation, in the accompanying drawings, wherein:

FIG. 1 illustrates an exemplary wireless broadcast network in accordance with the principles of the present invention;

FIG. 2 illustrates a logical diagram of a wireless handset for receiving broadcast content within the environment of FIG. 1;

FIG. 3 depicts a flowchart of an exemplary method for awakening a wireless broadcast handset from a low-power sleep mode in accordance with the principles of the present invention;

FIG. 4 depicts a flowchart of an exemplary method for receiving notification messages in a power-efficient manner;

FIG. 5 depicts an exemplary superframe that can be used to provide content within a wireless broadcast network such as that of FIG. 1;

FIG. 6 depicts a block diagram of a wireless broadcast base station and handset; and

FIG. 7 illustrates an alternative logical diagram of a wireless handset for receiving broadcast content within the environment of FIG. 1.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Techniques for broadcasting different types of transmissions (e.g., local and wide-area transmissions) in a wireless broadcast network are described herein. As used herein, “broadcast” and “broadcasting” refer to transmission of content/data to a group of users of any size and may also be referred to as “multicast” or some other terminology. A wide-area transmission is a transmission that may be broadcast by all or many transmitters in the network. A local transmission is a transmission that may be broadcast by a subset of the transmitters for a given wide-area transmission. Different local transmissions may be broadcast by different subsets of the transmitters for a given wide-area transmission. Different wide-area transmissions may also be broadcast by different groups of transmitters in the network. The wide-area and local transmissions typically carry different contents, but these transmissions may also carry the same content.

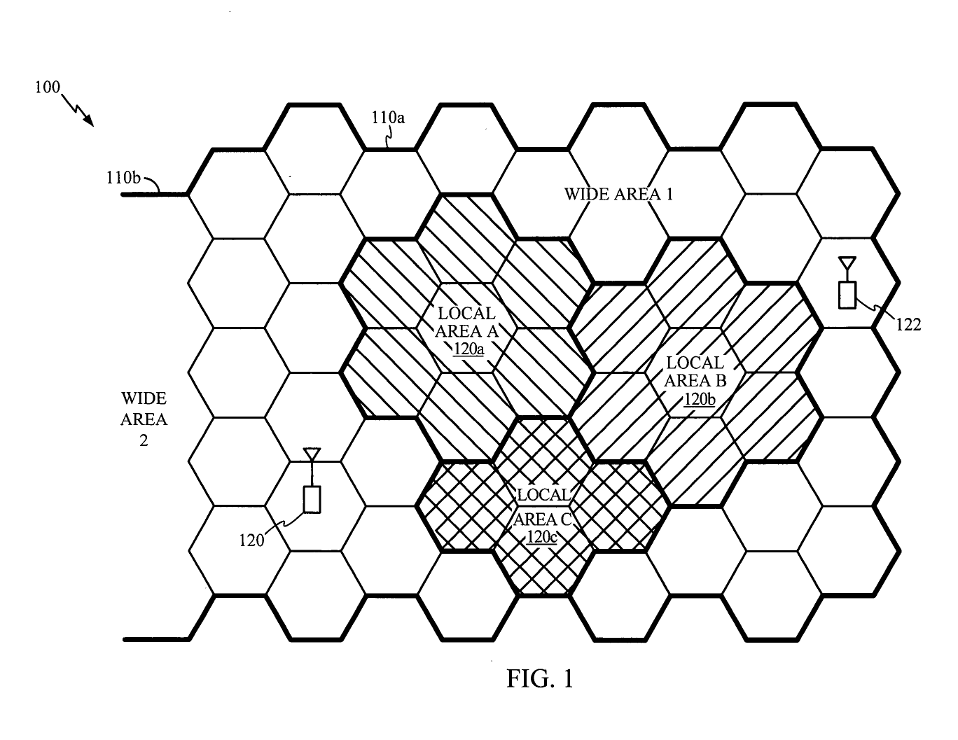

FIG. 1 shows a wireless broadcast network 100 that can broadcast different types of transmission such as, for example, wide-area transmissions and local transmissions. Each wide-area transmission is broadcast by a set of base stations in the network, which may include all or many base stations in the network. Each wide-area transmission is typically broadcast over a large geographic area. Each local transmission is broadcast by a subset of the base stations in a given set for a given wide-area transmission. Each local transmission is typically broadcast over a smaller geographic area. For simplicity, the large geographic area for a wide-area transmission is also called a wide coverage area or simply a “wide area”, and the smaller geographic area for a local transmission is also called a local coverage area or simply a “local area”. Network 100 may have a large coverage area such as the entire United States, a large region of the United States (e.g., the western states), an entire state, and so on. For example, a single wide-area transmission may be broadcast over the entire state of California, and different local transmissions may be broadcast over different cities such as Los Angeles and San Diego.

For simplicity, FIG. 1 shows network 100 covering wide areas 110a and 110b, with wide-area 110a encompassing three local areas 120a, 120b, and 120c. In general, network 100 may include any number of wide areas with different wide-area transmissions and any number of local areas with different local transmissions. Each local area may adjoin another local area or may be isolated. Network 100 may also broadcast any number of different types of transmission designated for reception over geographic areas of any number of different sizes. For example, network 100 may also broadcast a venue transmission designated for reception over a smaller geographic area, which may be portion of a given local area.

One example of such a broadcast network is the QUALCOMM MediaFLO™ network that delivers a programming lineup with a bit rate of about 2 bits per second per Hz. The technology used is an orthogonal frequency division multiplexing (OFDM)-based air interface designed specifically for multicasting a significant volume of rich multimedia content cost effectively to wireless subscribers. It takes advantage of multicasting technology in a single-frequency network to significantly reduce the cost of delivering identical content to numerous users simultaneously. Furthermore, the coexistence of local and wide area coverage within a single RF channel (e.g., 700 MHz) is supported as described above. This segmentation between wide area and local area supports more targeted programming, local advertising, and the ability to blackout and retune as required. MediaFLO™ is merely an example of the type of broadcast networks described herein and other, functionally equivalent broadcast networks are contemplated as well.

Much like cable TV, a subscriber within a wireless broadcast network can subscribe to different packages and tiers of service (e.g., premium movies, sports, etc.) that provide them with a set of channels (e.g., tennis, ESPN, soap operas, BBC, etc.). Different content providers forward the content to the broadcast network which then combines the content and broadcast it according to a predetermined schedule. During provisioning of a user's mobile device the capability to receive and decode the channels to which the user subscribes is programmed into the mobile device. The provisioning may be subsequently updated to remove or add other packages and channels. Thus, there is a broadcast network operator that broadcasts a variety of content, but there is also the carrier (e.g., Verizon, Xingular, etc.), who provisions the handsets, that determine what portions of the content can be subscribed to by a user of the carrier. One of ordinary skill will recognize that the hierarchical arrangement of channels just described is merely one example of how to provide multimedia and other content. Other arrangements and organization of the data and its respective channels may be utilized without departing from the scope of the present invention.

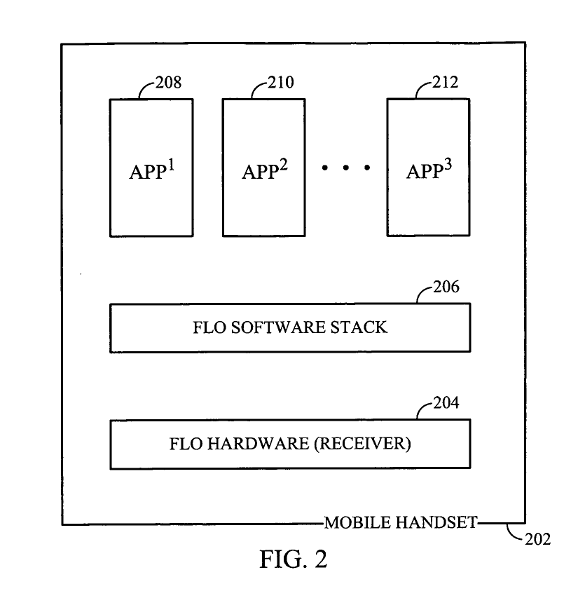

A logical view of a mobile handset for operation within a wireless broadcast network is illustrated in FIG. 2. In particular, there are a number of different applications 208, 210, 212 that execute within the operating system of the handset 202 to receive content that is broadcast over the wireless broadcast network. These applications 208, 210, 212, may, for example, include streaming video viewers, streaming audio players, news services, stock services, sports scorers, etc. They typically operate within a wireless operating system such as BREW or its equivalents.

Logically, these applications sit on “top” of a software stack 206 that itself communicates with the hardware 204 of the handset 202. In operation, the hardware (e.g., receiver) is configured to receive the signals broadcast over the wireless broadcast network and to pass them through to the software stack 206. The software stack 206 unencapsulates the signals received from the hardware layer 204 and provides them in an appropriate format to the different applications 208, 210, 212.

If the hardware, such as the receiver, 204 remains active at all times, then the battery of the handset 202 will drain quickly and will need to be replaced or recharged to continue operation of the handset 202. Alternatively, the hardware 204 may be powered-down at all times that no application 208, 210, 212 is actively receiving data but when an application is initiated data transfer, then the hardware 204 is activated out of its powered-down mode. While this latter alternative does provide power savings, it does so at the expense of the handset 202 being unable to receive any information unless an application 208, 210, 212 is actively receiving data.

In between the two extremes discussed above, there exists an intermediate solution in which the handset 202 remains in a sleep mode when no applications are receiving data but also periodically awakens to detect if any notifications or changes have occurred while it was asleep. After checking for changes or notifications, the handset returns to its lower-power sleep mode. The sleep mode is lower-power because the broadcast network receiver and associated circuitry (demodulator, demultiplexer, etc.) can be turned off.

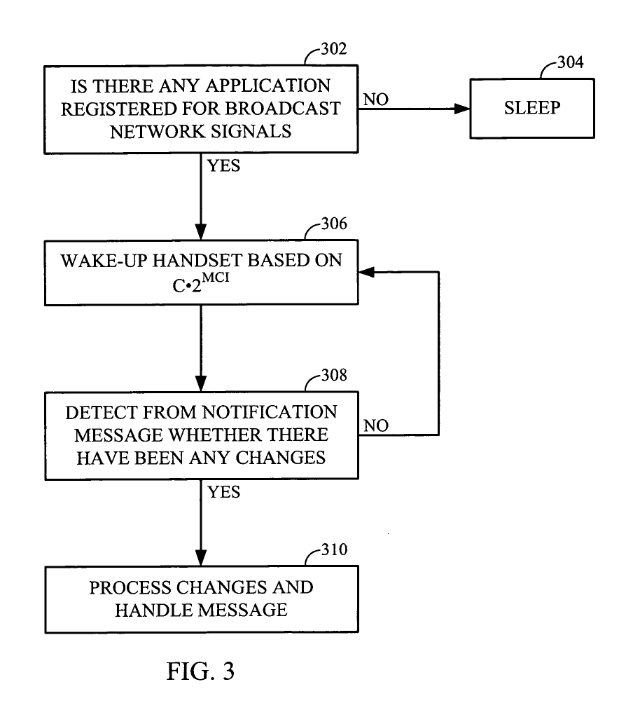

The flowchart of FIG. 3 depicts an exemplary method for providing power efficient operation of a wireless broadcast network handset. The flowchart assumes that no applications are actively receiving data. If an application were actively receiving data, then the handset would not be in sleep mode. In an optional step 302, a determination is made whether or not the handset includes any applications that would rely on or benefit from the notification messages that may be broadcast on a broadcast wireless network. If no such applications are present, then the handset is placed in sleep mode, in step 304, and will remain there until an application is actively initiated and executed by a user or an application is installed and registered that would benefit from the notification messages.

Assuming, however, that the handset has applications that would benefit from receiving notification or alert messages over the broadcast network, control passes to step 306. In this step, the handset remains in sleep mode but awakens at periodic intervals to check for alert or notification messages. There is an interval between active periods that is known as the sleep interval. Selecting the length of the sleep interval involves a trade-off. The longer the sleep interval, the greater the power savings. However, the shorter the sleep interval, the more responsive the handset is to notifications and alert messages. Thus, the sleep interval does not objectively have a “best” value but, rather, has a value that is more or less appropriate for the anticipated conditions of the network. Sleep intervals on the neighborhood of 1 to 2 minutes appear to be advantageous.

The types of notification messages that a handset can receive vary in nature. Some notification messages can be emergency alert messages from a civil defense organization, other notification messages can relate to weather or traffic or similar content. Still other notification messages can relate to the broadcast network itself. For example, some sporting events (or other content) may have “black-out” conditions that can change based on variable conditions and the notification messages can relate to these types of content availability issues. Other notification messages can alert a user to impending broadcast of content for which the user has been waiting.

As described earlier, the content that is available at a particular handset is a function of both the broadcast network operator and the carrier who provisions the handset to the user. Together, these parties determine which content is available through the handset. In this manner, the carrier has some control over what types of notification and alert messages will be received at handsets which it provisions. Thus, in FIG. 1, the handsets 120, 122 may have been provisioned by different carriers and have the capability to receive different sets of the broadcast content of the wide area network 110a.

Accordingly, the sleep interval for the handset 120 may not necessarily need to be the same as that of the handset 122. If the carrier provisioning handset 122 only offers content services where notification and alert messages are infrequent, then the handset 122 can have a sleep interval longer than that of the handset 120. Thus, the sleep interval for the handsets 120, 122 are determined, at least in part, by the respective carrier provisioning those handsets. In particular, as shown in step 306, a sleep interval having a length (in seconds) of
Sleep interval=c·2^{MCI}
is contemplated.

The value of c is a constant that is selected and set by the carrier provisioning a handset. Additionally, the value of c may be set by a number of other parties as well and can be accomplished using an appropriate application to write a hardware configuration file to the mobile handset. For example, an organization (e.g., Ford Motor Company) selling phones, or providing them as a promotional item, may configure c according to how they expect the mobile handsets to be used. Even within the same carrier, different handsets may have different values of c. For example, based on the capability of the handset (e.g., bigger battery, larger display screen, etc.), a carrier (or other party) may customize c accordingly. Thus, the value for c for handset 120 may be different than that set for handset 122. The value for the monitor cycle index (MCI) is set by the wireless broadcast network and transmitted within the channel control information included in its broadcast signals; however, the value of c is separate and controlled by another entity. In operation, the handset has a processor or some other timer component that calculates the sleep interval based on these two values. Advantageously, MCI can be a 4-bit value ranging from 0000 to 1111 such that if c=5, the sleep interval would range from 5 to 163,840 seconds.

When the handset awakens, then, in step 308, it can check to see if any new notification messages have been sent. Because, the handset and the broadcast network have an agreed-upon protocol for the format and content of the broadcast network signals, the handset knows to stay awake until the next notification update portion of the broadcast signal is received. If no notification message changes have occurred, then the handset returns to sleep and will awaken again after the sleep interval. If, however, a new notification message is received, then the handset will process the new information, in step 310. This processing is based on exactly what the new information is but may result, for example, in the user receiving content or other information via a user interface of the handset.

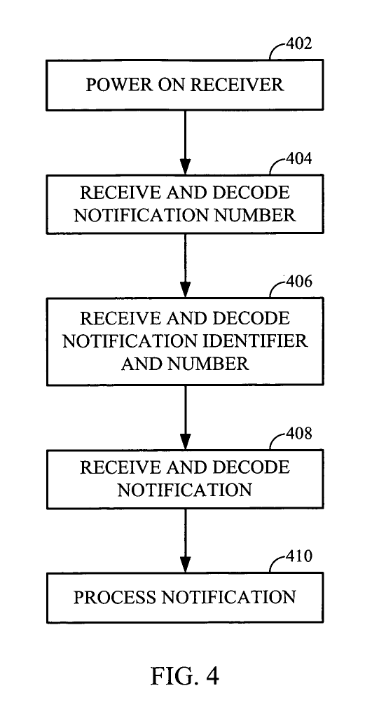

Because battery life can be extended the longer the handset receiver remains powered-off, it is advantageous to detect the notification message updates with this consideration in mind. For example, the transmitting of notification or alert messages can be accomplished in a manner that sends the information as three logical components. First is the concept of a global notification number, then there are the individual notification numbers, and finally there is the notification message itself. Using this logical separation of information allows the flowchart of FIG. 4 to monitor notification message updates in a power-efficient manner.

In step 402, the receiver is powered on and begins to detect and decode the broadcast network signal. However, there is no reason to decode the entire signal because the handset is only concerned with the portion of the signal dealing with notification messages. Thus, in step 404, the receiver decodes the portion of the broadcast network signal that includes a global notification number. This number is incremented by the wireless broadcast network each time a new notification message is sent. Thus, the handset (which maintains a copy of the latest global notification number it had previously encountered) compares its stored value with the just-received value. If the numbers are the same, then the handset can go back to sleep because there have been no new notification messages sent.

If, however, the numbers are different, then the handset stays awake long enough to receive and decode a notification identifier and number portion of the broadcast signal. This information can be pictured as the table below:

Notification Type

| | Alert1 | Alert2 | Alert3 | Alert4 |
|---|---|---|---|---|
| Number | a | b | c | d |

There are different possible notification messages that can broadcast, some may be of interest to the handset and some may not be (depending on the carrier's offerings). These different types of possible messages are the columns of the table and each notification message has its latest number assigned (e.g., a, b, c, d) and broadcast. Thus, in step 406, the handset receives and decodes the information from the table. Because the handset has an already-stored number value corresponding to each type of notification message, the handset can compare the newly received number to its stored values to determine exactly which one(s) of the notification messages is new. Using this information, the handset receiver will stay awake to receive and decode, in step 408, the actual content of the new notification message. Once decoded, the handset can process the message, in step 410, appropriately.

The specific way in which the broadcast network signals can be arranged and broadcast can vary greatly without departing from the spirit and scope of the present invention. Additionally, the particular format and encoding of notification messages and control channel information can vary as well. Described below, however, is one particular implementation of a wireless broadcast network within which the methods depicted in flowcharts 3 and 4 may be implemented.

More particularly, the data, pilots, and overhead information for local and wide-area transmissions may be multiplexed in various manners. For example, the data symbols for the wide-area transmission may be multiplexed onto a “transmission span” allocated for the wide-area transmission, the data symbols for the local transmission may be multiplexed onto a transmission span allocated for the local transmission, the TDM and/or FDM pilots for the wide-area transmission may be multiplexed onto a transmission span allocated for these pilots, and the TDM and/or FDM pilots for the local transmission may be multiplexed onto a transmission span allocated for these pilots. The overhead information for the local and wide-area transmissions may be multiplexed onto one or more designated transmission spans. The different transmission spans may correspond to (1) different sets of frequency subbands if FDM is utilized by the wireless broadcast network, (2) different time segments if TDM is utilized, or (3) different groups of subbands in different time segments if both TDM and FDM are utilized. Various multiplexing schemes are described below. More than two different types of transmission with more than two different tiers of coverage may also be processed, multiplexed, and broadcast. A wireless device in the wireless broadcast network performs the complementary processing to recover the data for the local and wide-area transmissions.

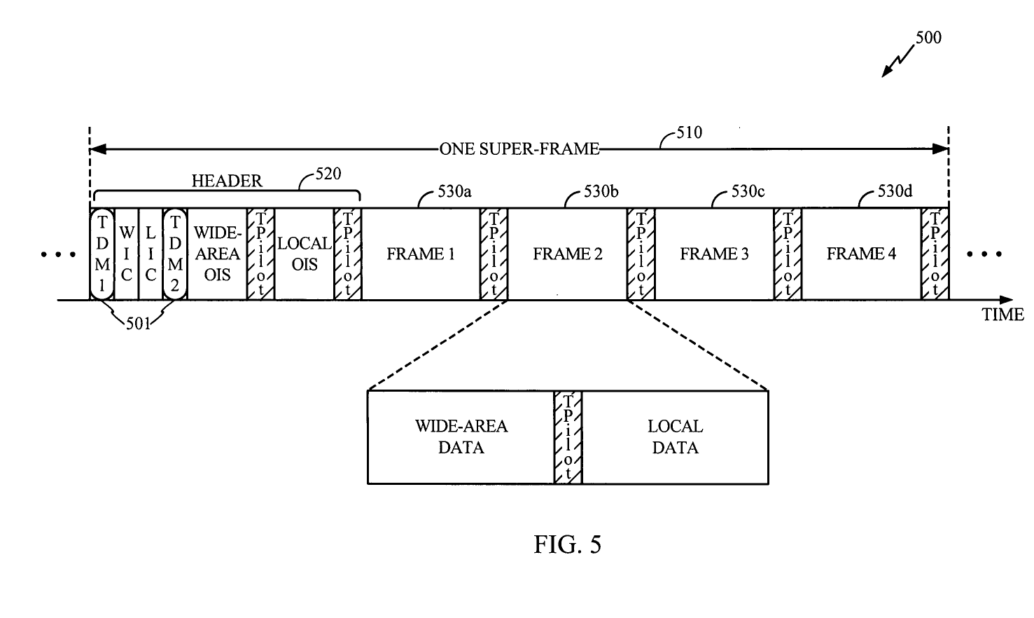

FIG. 5 shows an exemplary super-frame structure 500 that may be used to broadcast local and wide-area transmissions in an OFDM-based wireless broadcast network. Data transmission occurs in units of super-frames 510. Each super-frame spans a predetermined time duration, which may be selected based on various factors such as, for example, the desired statistical multiplexing for data streams being broadcast, the amount of time diversity desired for the data streams, acquisition time for the data streams, buffer requirements for the wireless devices, and so on. A super-frame size of approximately one second may provide a good tradeoff between the various factors noted above. However, other super-frame sizes may also be used.

For the embodiment shown in FIG. 5, each super-frame 510 includes a header segment 520, four equal-size frames 230a through 530d, and a trailer segment 540, which are not shown to scale in FIG. 5. Table 1 lists the various fields for segments 520 and 540 and for each frame 530.

| Fields | Description |
|---|---|
| TDM Pilot | TDM Pilot used for signal detection, frame synchronization, |
| | frequency error estimation, and time synchronization |
| Transition | Pilot used for channel estimation and possibly time |
| Pilot | synchronization and sent at the boundary of wide-area and |
| | local fields/transmissions |
| WIC | Wide-Area identification channel - carries an identifier |
| | assigned to the wide-area being served |
| LIC | Local identification channel - carries an identifier |
| | assigned to the local area being served |
| Wide-Area | Wide-Area overhead information symbol - carries overhead |
| OIS | information (e.g., frequency/time location and allocation) |
| | for each data channel being sent in the wide-area data field |
| Local OIS | Local overhead information symbol - carries overhead |
| | information for each data channel being sent in the |
| | local data field |
| Wide-Area | Carries data channels for the wide-area transmission |
| Data | |
| Local Data | Carries data channels for local transmission |

For the embodiment shown in FIG. 5, different pilots are used for different purposes. A pair of TDM pilots 501 are transmitted at or near the start of each super-frame and may be used for the purposes noted in Table 1. A transition pilot is sent at the boundary between local and wide-area fields/transmissions, and allows for seamless transition between the local and wide-area fields/transmissions.

The local and wide-area transmissions may be for multimedia content such as video, audio, teletext, data, video/audio clips, and so on, and may be sent in separate data streams. For example, a single multimedia (e.g., television) program may be sent in three separate data streams for video, audio, and data. The data streams are sent on data channels. Each data channel may carry one or multiple data streams. A data channel carrying data streams for a local transmission is also called a “local channel”, and a data channel carrying data streams for a wide-area transmission is also called a “wide-area channel”. The local channels are sent in the Local Data fields and the wide-area channels are sent in the Wide-Area Data fields of the super-frame.

Each data channel may be “allocated” a fixed or variable number of interlaces in each super-frame depending on the payload for the data channel, the availability of interlaces in the super-frame, and possibly other factors. Each data channel may be active or inactive in any given super-frame. Each active data channel is allocated at least one interlace. Each active data channel is also “assigned” specific interlaces within the super-frame based on an assignment scheme that attempts to (1) pack all of the active data channels as efficiently as possible, (2) reduce the transmission time for each data channel, (3) provide adequate time-diversity for each data channel, and (4) minimize the amount of signaling needed to indicate the interlaces assigned to each data channel. For each active data channel, the same interlace assignment may be used for the four frames of the super-frame.

The Local OIS field indicates the time-frequency assignment for each active local channel for the current super-frame. The Wide-Area OIS field indicates the time-frequency assignment for each active wide-area channel for the current super-frame. The Local OIS and Wide-Area OIS are sent at the start of each super-frame to allow the wireless devices to determine the time-frequency location of each data channel of interest in the super-frame.

The various fields of the super-frame may be sent in the order shown in FIG. 5 or in some other order. In general, it is desirable to send the TDM pilot and overhead information early in the super-frame so that the TDM pilot and overhead information can be used to receive the data being sent later in the super-frame. The wide-area transmission may be sent prior to the local transmission, as shown in FIG. 5, or after the local transmission.

FIG. 5 shows a specific super-frame structure. In general, a super-frame may span any time duration and may include any number and any type of segments, frames, and fields. However, there is normally a useful range of super-frame durations related to acquisition time and cycling time for the receiver electronics. Other super-frame and frame structures may also be used for broadcasting different types of transmission, and this is within the scope of the invention.

The pilot signals of FIG. 5 that are transmitted during the broadcast transmission may be used to derive (1) a channel estimate for the wide-area transmission, which is also called a wide-area channel estimate, and (2) a channel estimate for the local transmission, which is also called a local channel estimate. The local and wide-area channel estimates may be used for data detection and decoding for the local and wide-area transmissions, respectively. These pilots may also be used for channel estimation, time synchronization, acquisition (e.g., automatic gain control (AGC)), and so on. The transition pilot may also be used to obtain improved timing for the local transmission as well as the wide-area transmission.

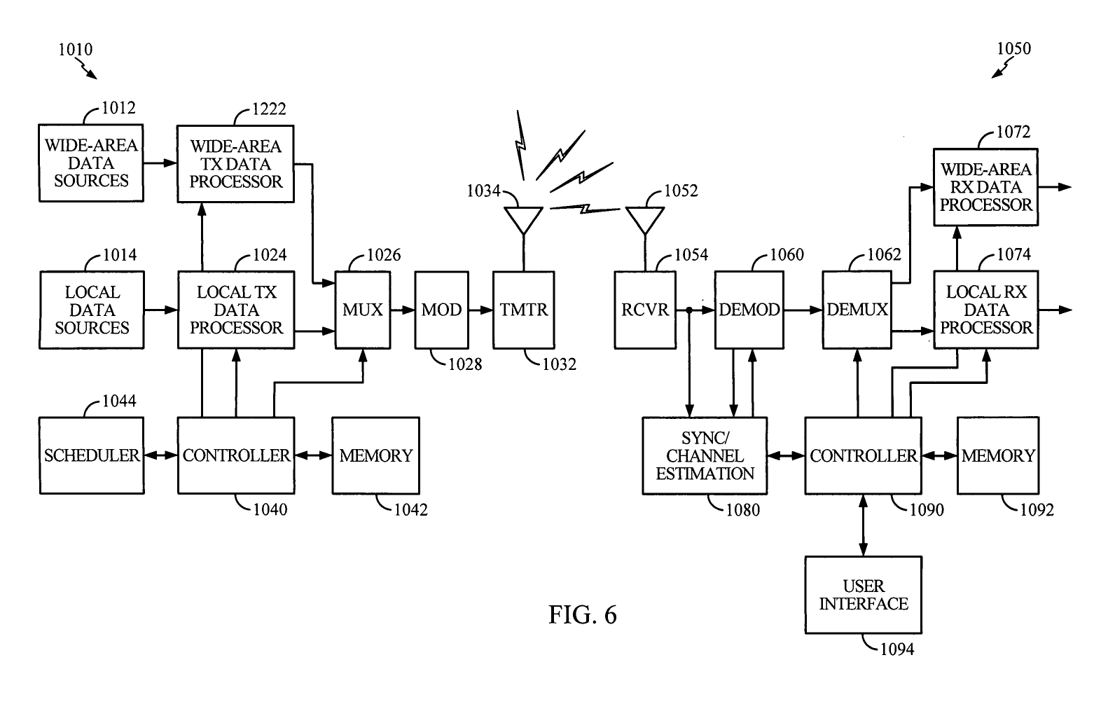

FIG. 6 shows a block diagram of a base station 1010 and a wireless device 1050 in wireless broadcast network 100 in FIG. 1. Base station 1010 is generally a fixed station and may also be called an access point, a transmitter, or some other terminology. Wireless device 1050 may be fixed or mobile and may also be called a user terminal, a mobile station, a receiver, or some other terminology. Wireless device 1050 may also be a portable unit such as a cellular phone, a handheld device, a wireless module, a personal digital assistant (PDA), and so on.

At base station 1010, a transmit (TX) data processor 1022 receives data for a wide-area transmission from sources 1012, processes (e.g., encodes, interleaves, and symbol maps) the wide-area data, and generates data symbols for the wide-area transmission. A data symbol is a modulation symbol for data, and a modulation symbol is a complex value for a point in a signal constellation for a modulation scheme (e.g., M-PSK, M-QAM, and so on). TX data processor 1022 also generates the FDM and transition pilots for the wide area in which base station 1010 belongs and provides the data and pilot symbols for the wide area to a multiplexer (Mux) 1026. A TX data processor 1024 receives data for a local transmission from sources 1014, processes the local data, and generates data symbols for the local transmission. TX data processor 1024 also generates the pilots for the local area in which base station 1010 belongs and provides the data and pilot symbols for the local area to multiplexer 1026. The coding and modulation for data may be selected based on various factors such as, for example, whether the data is for wide-area or local transmission, the data type, the desired coverage for the data, and so on.

Multiplexer 1026 multiplexes the data and pilot symbols for the local and wide areas as well as symbols for overhead information and the TDM pilot onto the subbands and symbol periods allocated for these symbols. A modulator (Mod) 1028 performs modulation in accordance with the modulation technique used by network 100. For example, modulator 1028 may perform OFDM modulation on the multiplexed symbols to generate OFDM symbols. A transmitter unit (TMTR) 1032 converts the symbols from modulator 1028 into one or more analog signals and further conditions (e.g., amplifies, filters, and frequency upconverts) the analog signal(s) to generate a modulated signal. Base station 1010 then transmits the modulated signal via an antenna 1034 to wireless devices in the network.

At wireless device 1050, the transmitted signal from base station 1010 is received by an antenna 1052 and provided to a receiver unit (RCVR) 1054. Receiver unit 1054 conditions (e.g., filters, amplifies, and frequency downconverts) the received signal and digitizes the conditioned signal to generate a stream of data samples. A demodulator (Demod) 1060 performs (e.g., OFDM) demodulation on the data samples and provides received pilot symbols to a synchronization (Sync)/channel estimation unit 1080. Unit 1080 also receives the data samples from receiver unit 1054, determines frame and symbol timing based on the data samples, and derives channel estimates for the local and wide areas based on the received pilot symbols for these areas. Unit 1080 provides the symbol timing and channel estimates to demodulator 1060 and provides the frame timing to demodulator 1060 and/or a controller 1090. Demodulator 1060 performs data detection on the received data symbols for the local transmission with the local channel estimate, performs data detection on the received data symbols for the wide-area transmission with the wide-area channel estimate, and provides detected data symbols for the local and wide-area transmissions to a demultiplexer (Demux) 1062. The detected data symbols are estimates of the data symbols sent by base station 1010 and may be provided in log-likelihood ratios (LLRs) or some other form.

Demultiplexer 1062 provides detected data symbols for all wide-area channels of interest to a receive (RX) data processor 1072 and provides detected data symbols for all local channels of interest to an RX data processor 1074. RX data processor 1072 processes (e.g., deinterleaves and decodes) the detected data symbols for the wide-area transmission in accordance with an applicable demodulation and decoding scheme and provides decoded data for the wide-area transmission. RX data processor 1074 processes the detected data symbols for the local transmission in accordance with an applicable demodulation and decoding scheme and provides decoded data for the local transmission. In general, the processing by demodulator 1060, demultiplexer 1062, and RX data processors 1072 and 1074 at wireless device 1050 is complementary to the processing by modulator 1028, multiplexer 1026, and TX data processors 1022 and 1024, respectively, at base station 1010.

Controllers 1040 and 1090 direct operation at base station 1010 and wireless device 1050, respectively. These controllers may be hardware-based, software-based or a combination of both. Memory units 1042 and 1092 store program codes and data used by controllers 1040 and 1090, respectively. A scheduler 1044 schedules the broadcast of local and wide-area transmissions and allocates and assigns resources for the different transmission types.

For clarity, FIG. 6 shows the data processing for the local and wide-area transmissions being performed by two different data processors at both base station 1010 and wireless device 1050. The data processing for all types of transmission may be performed by a single data processor at each of base station 1010 and wireless device 1050. FIG. 3 also shows the processing for two different types of transmission. In general, any number of types of transmission with different coverage areas may be transmitted by base station 1010 and received by wireless device 1050. For clarity, FIG. 3 also shows all of the units for base station 1010 being located at the same site. In general, these units may be located at the same or different sites and may communicate via various communication links. For example, data sources 1012 and 1014 may be located off site, transmitter unit 1032 and/or antenna 1034 may be located at a transmit site, and so on. A user interface 1094 is also in communication with the controller 1090 that allows the user of the device 1050 to control aspects of its operation. For example, the interface 1094 can include a keypad and display along with the underlying hardware and software needed to prompt a user for commands and instructions and then to process them once they are received.

Within the specific context of FIGS. 5 and 6, the notification messages and other related signals can be configured a variety of different ways. For example, the Wide Area OIS (or even the Local Area OIS) can include a field that contains one or more bits representing the MCI value. Within such a configuration, the MCI value can change if the broadcast network operator changes the value and, therefore, the sleep interval for all handsets will change as well. Accordingly, the broadcast network operator may elect not to change the MCI value except in extraordinary circumstances. The memory 1092 of the handset 1050 can have a non-volatile portion, for example, that stores a configuration file embedded when the carrier provisions the handset. Part of the configuration file can include the constant c that is used in determining the sleep interval. The memory 1094 can also include a portion for storing the current values for the global notification message number and the number of each of the individual notification messages.

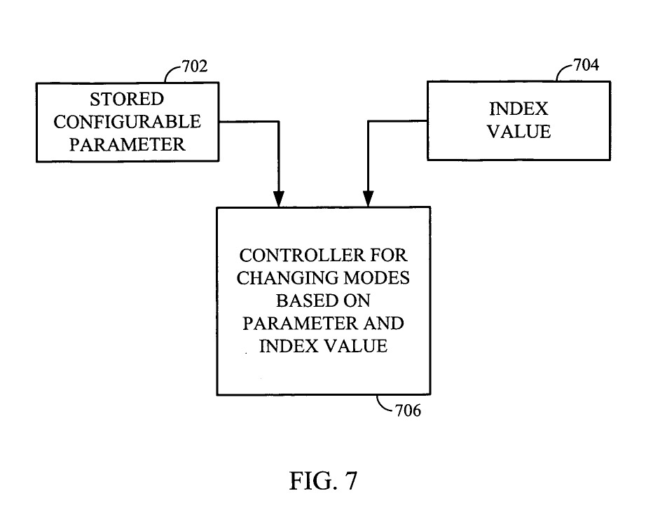

FIG. 7 depicts a functional block diagram of a handset operable according to the above description. In particular, a controller is provided for changing the modes of operation of the handset. If the device is being actively used, then the controller may wait for a period of time of inactivity before changing the handset to a lower power mode. Alternatively, if the handset is operating in a low power mode (e.g., sleep, idle, etc.), the controller may periodically awaken the handset where it may stay awake if there is pending activity or it may return to its low power mode. The sleep interval of the handset is determined based on two different components. First, there is a configurable parameter stored within the handset and, secondly, there is an index value broadcast by the wireless broadcast network. The controller uses these two values together to determine the sleep interval of the handset.

The techniques described herein for broadcasting different types of transmission over the air may be implemented by various means. For example, these techniques may be implemented in hardware, software, or a combination thereof. For a hardware implementation, the processing units at a base station used to broadcast different types of transmission may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. The processing units at a wireless device used to receive different types of transmission may also be implemented within one or more ASICs, DSPs, and so on.

For a software implementation, the techniques described herein may be implemented with modules (e.g., procedures, functions, and so on) that perform the functions described herein. The software codes may be stored in a memory unit (e.g., memory unit 1042 or 1092 in FIG. 3) and executed by a processor (e.g., controller 1040 or 1090). The memory unit may be implemented within the processor or external to the processor, in which case it can be communicatively coupled to the processor via various means as is known in the art.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A mobile communications device, comprising:
a receiver configured to receive signals from a wireless broadcast network when operating in a first mode;
a memory configured to store a configurable parameter; and
a processor configured to periodically alternate operating the receiver in a second mode and the first mode, the second mode being a lower power mode as compared to the first mode, and wherein operating in the second mode lasts for a predetermined interval, a length of which based on the configurable parameter and an index value received from the wireless broadcast network.

2. The mobile communications device of claim 1, wherein in the second mode the receiver is powered down.

3. The mobile communications device of claim 1, wherein the receiver comprises a demodulator and a demultiplexer.

4. The mobile communications device of claim 3, wherein in the second mode at least one of the demodulator and demultiplexer is powered down.

5. The mobile communications device of claim 1, wherein:
the processor is further configured, upon changing operation of the receiver from the second mode to the first mode, to determine if a notification message was transmitted in the wireless broadcast network while the receiver was operated in a most recent interval in the second mode.

6. The mobile communications device of claim 1, wherein
the processor is further configured, upon changing operation of the receiver from the second mode to the first mode, to determine if the signals from the wireless broadcast network include an indication that a notification message update occurred while the receiver was operated in a most recent interval in the second mode.

7. The mobile communications device of claim 6, wherein the indication comprises a label that uniquely indicates whether a new notification message was transmitted during the most recent interval.

8. The mobile communications device of claim 6, wherein
the processor is configured to:
a) return to operating the receiver in the second mode if the indication is not present; and
b) continue operating the receiver in the first mode if the indication is present in order to receive the notification message update.

9. The mobile communications device of claim 1, wherein the configurable parameter is determined by a provisioner of the mobile communications device.

10. The mobile communications device of claim 9, wherein the configurable parameter is set within a configuration file stored in the memory when the device is initially provisioned.

11. The mobile communications device of claim 1, wherein the length of the predetermined interval, in seconds, is calculated according to (configurable parameter)×2ˆ(index value).

12. The mobile communications device of claim 1, wherein the configurable parameter is a positive number.

13. The mobile communications device of claim 12, wherein the configurable parameter comprises a non-negative real number.

14. The mobile communications device of claim 1, wherein the index value is transmitted within a control channel of the wireless broadcast network.

15. A method of operating a mobile communications device comprising:
a) operating a receiver of the device in a first mode for a predetermined interval, wherein a length of the interval depends on an index value received from the wireless broadcast network and a configurable parameter stored in the device;
b) after expiration of the predetermined interval, operating the receiver of the device in a second mode to receive signals from a wireless broadcast network, wherein operating in the first mode consumes less power than operating in the first mode;
c) while the receiver is operating in the first mode, determining whether the signals include an indication that a notification message update occurred during a most recent operating interval in the first mode;
d) if there is the indication, then remain operating the receiver in the second mode to determine an update; and
e) if there is no indication, then return to operating the receiver in the first mode and repeat steps a)-c).

16. The method of claim 15, wherein in the first mode the receiver is powered down.

17. The method of claim 15, wherein the length of the predetermined interval, in seconds, is calculated according to (configurable parameter)×2ˆ(index value).

18. The method of claim 15, wherein the configurable parameter is a positive number.

19. The method of claim 17, wherein the configurable parameter comprises a non-negative real number.

20. The method of claim 15, wherein the index value is transmitted within a control channel of the wireless broadcast network.

21. A mobile communications device, comprising:
a receiver configured to operate in either an active mode or a sleep mode, wherein the sleep mode provides lower power consumption compared to the active mode;
a memory configured to store a configurable parameter; and
a processor configured to:
operate the receiver in the active mode to receive signals from a wire less broadcast network;
decode an index value contained within a control channel of the signals;
operate the receiver in the sleep mode for a predetermined interval, the predetermine interval having a length dependent on both the configurable parameter and the index value; and
change the receiver from the sleep mode to the active mode at the end of the interval.

22. The mobile communications device of claim 21, wherein in the sleep mode the receiver is powered down.

23. The mobile communications device of claim 21, wherein:
the processor is further configured to change the receiver from the active mode to the sleep mode to begin the interval.

24. The mobile communications device of claim 21, wherein the configurable parameter is set within a configuration file stored in the memory when the device is initially provisioned.

25. The mobile communications device of claim 21, wherein:
the processor is further configured to:
upon the receiver changing from the sleep mode to the active mode, determine if a notification update message was transmitted by the wireless broadcast network during a most recent interval in the sleep mode;
if so, operate the receiver to receive and decode an update from the wireless broadcast network; or
if not, change the receiver from the active mode to the sleep mode.

26. A mobile communications device having a receiver configured to receive signals from a wireless broadcast network when operating in a first mode, comprising;
means for storing a configurable parameter; and
means for periodically alternating operating of the receiver in a second mode and the first mode, the second mode being a lower power mode as compared to the first mode, and wherein operating in the second mode lasts for a predetermined interval, a length of which based on the configurable parameter and an index value received from the wireless broadcast network.
